(19) United States
(12) Patent Application Publication
(10) Pub. No.: US 2004/0164897 A1
(43) Pub. Date: Aug. 26, 2004

(54) Apparatus and method for recording real time movements and experiences for subsequent replay in a virtual reality domain

(76) Inventors: Simon Treadwell, Etobicoke (CA); Alastair Jenkins, Etobicoke (CA)

Correspondence Address: MEREK, BLACKMON & VOORHEES, LLC, 673 South Washington Street, Alexandria, VA, 22314, US

(21) Appl. No.: 10/779,798

(22) Filed: Feb. 18, 2004

Related U.S. Application Data
(60) Provisional application No. 60/448,865, filed on Feb. 24, 2003.

(51) Int. Cl. H01Q 3/22

(52) U.S. Cl. 342/358; 342/375

(57) ABSTRACT

An apparatus to permit real time movements and events experienced by one or more individuals to be recorded for subsequent replay in a virtual reality domain. The apparatus comprises a GPS receiver for receiving a plurality of GPS signals, a processor operatively connected to the GPS receiver and programmed to calculate the position of the receiver relative to the surface of the earth, a memory module operatively connected to the processor, and means to permit data corresponding to the movement of the GPS receiver and data corresponding to events experienced by the operator to be downloaded into the memory of a secondary processor. The processor stores in the memory module data corresponding to the calculated position of the GPS receiver and the movement of the GPS receiver for a given time interval. The memory module also stores data corresponding to specific events experienced by an operator of the apparatus during the time interval. After the data has been downloaded into the memory of a secondary processor the events experienced by the operator and the movement of the receiver may be replayed in a virtual reality domain.

### FIELD OF THE INVENTION

This invention relates to both an apparatus and a method for recording real time movement and events experienced by one or more individuals and that permits the subsequent replay of those real time movements and events in a virtual reality domain. The invention also relates to a means of gaming utilizing such an apparatus and method.

### BACKGROUND OF THE INVENTION

Games and events that take place out-of-doors are enjoyed by the young and old alike. There are an extremely wide variety of different games that individuals engage in as a form of recreation, sport, exercise and general competition. Aside from traditional sports such as baseball, football, hockey, and basketball, outdoor games and gaming may also include treasure hunts, traversing slalom courses or mazes, team games such as capture the flag, poker runs, and similar activities that may be played individually or simultaneously by a number of different individuals.

With the release of global positioning satellite (“GPS”) signals for use by the general public, GPS receivers have enjoyed wide spread use amongst the public, including those engaged in outdoor games and activities. A GPS receiver captures navigational signals from a series of satellites orbiting the earth to permit the calculation of relatively precise position co-ordinates in terms of latitude, longitude and elevation. Those co-ordinates may then be displayed on a screen to visually indicate the position of the receiver relative to localized fixed objects or on an overlay map or grid. Regardless, the advent of GPS technology has added a further dimension to gaming and gaming methods that enables an individual to determine the location of the GPS receiver (and hence himself or herself) relative to the surface of the earth or relative to specific fixed or moving objects.

To enhance gaming opportunities and experiences, others have proposed the integration of GPS technology and wireless communication devices into portable devices. In some cases GPS receivers and pagers have been combined to allow for communication between an individual GPS unit and a pager base station using pager technology. Still others have proposed combining GPS receivers with radio frequency transmitters and receivers that enable individual units to communicate with one another over a wireless radio network. More recently GPS receivers have been combined with mobile cellular telephones to permit communications between individuals over a cellular network.

Although gaming technology has been significantly advanced through the incorporation of GPS receivers, pagers, cellular telephones and radio transmitters into portable handheld game devices, existing gaming units are limited with respect to their ability to allow different individuals separated by considerable distances to engage in the same game or to play against one another. The radio frequency signals that are capable of being generated by the relatively small transmitters in portable handheld devices have a range of typically from 1 to 5 km. The use of pager or cellular technology carries with it a significant infrastructure cost, as well as in most instances a monthly or per unit time charge. The use of pager and cellular signals is also dependent upon localized transmission towers that may not be present in outlying areas. For these reasons the ability of individuals to play games and to engage in competitive activities with others separated by considerable distances is often severely limited, or may be prohibitively expensive. Further, under existing methods and currently available gaming devices, at the conclusion of the game or event the gaming device is turned off and the individual has no ability to re-live the adventure except through his or her own memories.

### SUMMARY OF THE INVENTION

The invention therefore provides both a method and an apparatus that may be used for gaming and/or for recording real time movements and experiences, and that thereafter permits the subsequent replay of those movements and experiences in a virtual reality domain. Through the employment of the inventive method and apparatus an individual may re-live the experience of engaging in the real time movements and events. The invention also permits individuals to play or compete against computers or other individuals situated in distant localities without the limitations and expense associated with the transmission of data through radio frequency, paging or cellular networks.

Accordingly, in one of its aspects the invention provides an apparatus to permit real time movements and events experienced by one or more individuals to be recorded for subsequent replay in a virtual reality domain, the apparatus comprising a GPS receiver for receiving a plurality of GPS signals from a plurality of satellites; a processor operatively connected to said GPS receiver and programmed to calculate the position of said GPS receiver relative to the surface of the earth based upon said received GPS signals; a memory module operatively connected to said processor, said processor storing in said memory module data corresponding to the calculated position of said GPS receiver and the movement of said GPS receiver for a time interval, said memory module further storing data corresponding to specific events experienced by an operator of said apparatus during said time interval; and, means to permit said data corresponding to the movement of said GPS receiver and said data corresponding to events experienced by said operator to be downloaded into the memory of a secondary processor for replaying and simulating said movement of said GPS receiver and the experiencing of said events in a virtual reality domain.

In a further aspect the invention provides a method of electronic gaming utilizing an electronic gaming unit wherein real time movements of one or more individuals or players are recorded for later replay in a virtual reality domain, the method comprising the steps; with a GPS receiver, receiving a plurality of GPS signals generated from a plurality of orbiting satellites and directing said received signals to a processor programmed to calculate the position of said GPS receiver relative to the surface of the earth based upon said received GPS signals; in a memory module operatively connected to said processor, storing data corresponding to the calculated position of said GPS receiver and data corresponding to the movement of said GPS receiver for a time interval; and, transporting said data corresponding to the position and the movement of said GPS receiver to a secondary processor for replaying and simulating said movement of said individual and said GPS receiver in a virtual reality domain.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is a plan view of a portable handheld gaming device constructed in accordance with a preferred embodiment of the present invention;

FIG. 2 is a schematic view of the electronic architecture of a preferred embodiment of the gaming apparatus shown in FIG. 1;

FIG. 3 is a sample of an image that may be displayed upon the display panel of an apparatus constructed in accordance with a preferred embodiment of the present invention;

FIG. 4 is a further example of an image that may be displayed upon the display panel of an apparatus constructed in accordance with a preferred embodiment of the present invention;

FIG. 5 is yet a further example of an image that may be displayed upon the display panel of an apparatus constructed in accordance with a preferred embodiment of the present invention;

FIG. 6 is another example of an image that may be displayed upon the display panel of an apparatus constructed in accordance with a preferred embodiment of the present invention;

FIG. 7 is another example of an image that may be displayed upon the display panel of an apparatus constructed in accordance with a preferred embodiment of the present invention;

FIG. 8 is another example of an image that may be displayed upon the display panel of an apparatus constructed in accordance with a preferred embodiment of the present invention;

FIG. 9 is a further example of an image that may be displayed upon the display panel of an apparatus constructed in accordance with a preferred embodiment of the present invention; and,

FIG. 10 is an example of a table that may be generated by a computer or processor to track the performance of different individuals utilizing the apparatus of the present invention.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

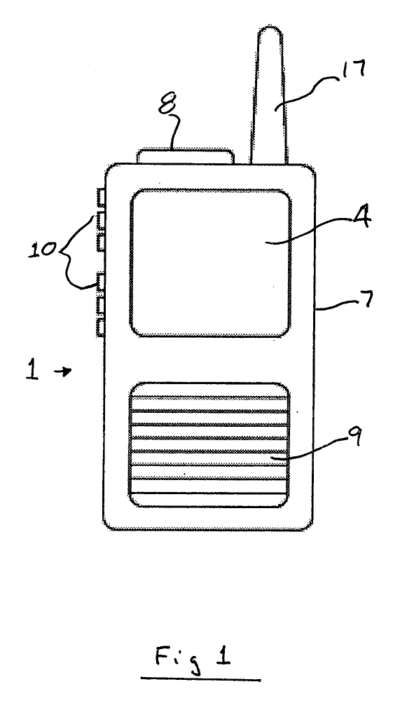

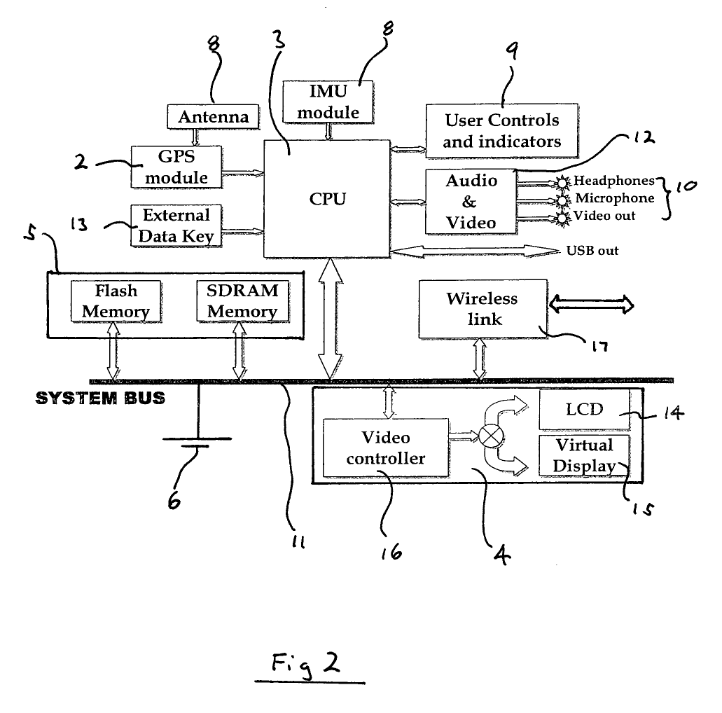

An apparatus constructed in accordance with one of the preferred embodiments of the invention is shown generally in FIG. 1 and schematically in FIG. 2. It will be appreciated following a thorough understanding of the invention that the apparatus shown in FIGS. 1 and 2 may be contained within a portable handheld housing that is powered by internal power supply or, alternatively, may be integrated into existing components of vehicles such as motorcycles, snowmobiles, personal water crafts, all terrain vehicles, etc. For illustration purposes the description of the apparatus that follows is that of a portable handheld device such as a portable gaming unit 1.

In FIGS. 1 and 2 portable gaming unit 1 is shown as comprised generally of a GPS module or receiver 2, a processor or central processing unit (CPU) 3, a display 4 and a memory module 5. Where unit 1 is portable in nature it will also preferably include an internal power source or a battery 6. As indicated in FIG. 1, in one embodiment of the invention the primary components of unit 1 are contained within a portable case or housing 7. Housing 7 may take any one of extremely wide variety of different physical configurations and the general shape of the housing as shown in FIG. 1 is merely a single example. In most instances display panel 4 will be positioned in an easy identifiable location on housing 7 and the housing will typically include a GPS antennae 8 and some form of keypad or user interface 9. The housing may also include one or more of a variety of different jacks or ports for purposes of connecting headphones, microphones, video output cables, external data cables, computer cables (such as USB cables), etc. In an alternate embodiment gaming unit 1 may be configured without a display panel. Where no display panel is present the images that would normally have been viewable on the display panel will typically be stored within memory module 5 for accessing at a later point in time through the use of a separate microprocessor or computer, or through the use of a display, printer or other output device that may be connected to processor 3.

As shown schematically in FIG. 2, the primary operational components of gaming unit 1 are operatively connected through the use of a system bus 11 to enable processor 3 to communicate with and control the various other components. As also indicated, memory module 5 preferably includes two portions, one of which may be a fixed memory portion of random access memory (RAM), the other of which is a removable portion which may take the form of a flash or compact flash memory card, a computer disk, a multimedia card, a micro drive, a portable memory stick or similar memory device. The removable portion may also be a segmented part of the fixed memory module that is accessible for downloading into a secondary processor or computer. In the case where gaming unit 1 is equipped with one or more jacks or ports 10, the ports will typically be connected to an audio/video controller 12 which may be directly connected to processor 3 or indirectly connected to the processor through system bus 11.

Where one of ports 10 comprises an external data input jack, that jack may be connected to a data controller 13 which may then be either directly connected to processor 3 or indirectly connected to the processor through the system bus. Finally, where gaming unit 1 includes a USB port, typically the USB port will be connected directly to processor 3 to allow for the direct transmission of data into or out of gaming unit 1.

Depending upon the desired end use of unit 1, where a display is present it may be comprised of a display panel or screen 14 or, alternatively, may be comprised of a heads-up or virtual display 15 formed through the projection of an image onto the surface of a visor or similar object to be worn by an operator. Where the display is comprised of a display panel it is expected that in most instances the panel will be a liquid crystal display (LCD) panel which could display images in black and white or in colour. Where a heads-up or virtual display is utilized it is anticipated that in most instances the display will be integrated into a hat or helmet to be worn by an operator such that an overlay map or grid can be projected onto a visor upon the hat or helmet that is generally positioned in the line of sight of the operator. Alternatively, the heads-up display may be incorporated into goggles or sun glasses and may be supported by a wired or wireless data transfer system. If the heads-up display is hard wired, transmission wires will connect the virtual display to gaming unit 1 through one or more of the jacks or ports positioned upon housing 7. Where a wireless data transfer method is used commercially available technology, such as Bluetooth™ or other similar systems known in the art, may be employed to transmit data from the unit to the heads-up display.

It should also be noted that the use of a display panel and a heads-up or virtual display is not mutually exclusive and that if desired both forms of displays could be used. In either case a video controller 16 is used to process data streams emanating from processor 3 in order to convert them into signals recognizable by display panel 14 and/or virtual display 15. It will therefore be appreciated that through the operation of display panel 14 and/or virtual display 15 processor 3 will be able to visually display to an operator the position of the GPS receiver relative to the surface of the earth or relative to an overlay map, grid or other image or object.

In one embodiment of the invention gaming unit 1 may further include one or more inertia measurement sensors 18 that may be used to help determine the attitude, acceleration, deceleration, and other spacial properties of the unit and its movement. Sensors 18 may be comprised of 1 or more accelerometers, gyroscopes or similar components that are preferably operatively connected to system bus 11. Measurements taken by sensors 18 may be received by processor 3 and either displayed directly on display panel 4 and/or heads up display 15 (where one or the other is present) or stored in memory for future retrieval and use. The measurements and data collected by sensors 18 will provide further detail concerning the precise location and movement of the gaming unit over and above the level of detail normally attained through the receipt of GPS signals alone. Such data will also enhance the reality of a simulation of the movement of the unit when later replayed in a virtual reality domain, as is discussed in more detail below.

Prior to the use of gaming unit 1, game or event software is loaded into memory module 5 to allow the unit to “play” a particular game or games, or to facilitate the operator in engaging in a particular event. For example, background topographical maps, slalom courses, treasure routes, or other forms of data may be received and stored into the unit's memory for subsequent use and recall during operation. Unit 1 may also be pre-programmed with a default topographical map or grid for a particular geographic area that can be later accessed by the processor to indicate the relative position of the unit on the default map based upon the receipt of GPS signals. Having the proper topographical maps downloaded or pre-programmed into unit 1 will permit the unit to be used as a standard GPS receiver when not engaged in gaming or similar activities. The data and programs may be loaded into unit 1 through connecting the unit to a personal computer or other processor by means of an external data port, or through a standard USB connection. However, it will be appreciated by those skilled in the art that in other instances it may be desirable to load or install game software, overlay maps or other display graphics through the use of removal memory modules, memory sticks, data cards, or similar types of transportable memory.

It should be also noted that gaming unit 1 may be assembled from the various components described above, or may be a hybridized version of an existing gaming device manufactured by others (for example, Gameboy™ by Nintendo™). In the instance where gaming unit 1 is based upon an existing manufactured product, typically the product's processor or microprocessor would be re-programmed to accommodate its new functionality and to permit the processor to compute geographical co-ordinates based upon received GPS signals. The unit would also typically need to be retrofitted with removal memory modules, additional user or operator controls or interfaces, a GPS module and antennae, and a wireless communication link, as will be described in more detail below. The system bus, power source and display panel of the existing device may be utilized without significant modification.

As mentioned above, gaming unit 1 may have incorporated within it a wireless communication link 17 that in most cases will be comprised of a radio frequency receiver and transmitter. In other cases wireless communication link 17 may include cellular or pager based receivers and transmitters. In any event, the respective receivers and transmitters are operatively connected to processor 3 to permit the receipt of wireless signals that may then be transmitted to the processor, thereby allowing the processor to display or alter the appearance of particular images on display panel 14 and/or heads-up display 15. For example, the signals received by wireless communication link 17 may be indicative of the location of one or more other similar gaming units thereby permitting processor 3 to analyze the signals that are received and identify the specific position of the one or more other units on display 4. Similarly, wireless communication link 17 may simultaneously transmit signals indicative of its particular location as determined by the processor in conjunction with the GPS module. Such signals may be transmitted and received by and between individual gaming units and/or individual units and a base station or central server to track and identify the location of specific units in a particular geographic area.

Where a base station or central server is utilized, wireless transmissions may be used to forward additional safety or gaming information to a particular gaming unit. The central server or base station may also be programmed to provide a supervisory level of monitoring and may permit the transmission of dynamic change parameters governing the nature and complexity of play in accordance with rules and objectives of the game to individual units. In other cases the base station or server may transmit warnings or indicators to particular gaming units that individuals are exceeding pre-defined boundaries or potentially engaging in unsafe activities. Continuous operation of wireless communication link 17 will essentially permit real time updates and interaction between multiple units and/or a central server or base station and allow for a continuous state of transmitting and receiving signals to provide real time player movement and information transfer. By way of example, where an individual operating a gaming unit is about to exceed a pre-defined boundary designated for a certain game or activity, a central server or base station monitoring the position of the gaming unit may send out a wireless signal informing the individual that he or she is about to approach a boundary limit. It may also be desirable to incorporate an audio alarm into unit 1 that may be activated in such instances so as to provide both a visual and audio signal to the individual. It will also be appreciated that similar alarms or visual indicators could be transmitted for purposes of notifying an operator of the status of certain game parameters, when an unsafe speed has been achieved where the operator is on a motorized vehicle, or a wide variety of other safety or game related parameters.

Once gaming unit 1 has been loaded with the appropriate software, overlay and topographical maps, and any other necessary information and data, operation of the unit will permit the device to act generally as a referee or game keeper and will track the playing of a game or the engagement of an individual in an event or activity. Unit 1 will not only track the geographic location of an individual player, or multiple players where more than one gaming unit is utilized, but will also be capable of tracking the interactions of a single gaming unit vis-a-vis particular geographic locations or multiple gaming units relative to each other according to both pre-programmed rules of the game and/or particular game boundaries.

Operation of gaming unit 1 also permits for the determination of a triggering event that may have certain consequences under the rules of the particular game or activity that is being enjoyed. For example, a fictitious slalom course may be overlain over a topographical map on display panel 14 wherein the fictitious course includes a finish line. As an individual moves over the face of the earth processor 3 will “track” his or her movements and display the individual's relative position upon display panel 14. To the individual it would appear that he or she is traversing the slalom course shown on the overlay. Once processor 3 determines that the geographic position of the individual vis-a-vis surface of the earth “matches” the location of the fictitious finish line, the processor will advise the individual that the course has been completed and may display a time associated with completing the course or a relative ranking in the event that a number of individuals using separate gaming units were engaged in traversing the course. In other games or activities a triggering event caused by an individual occupying a particular geographic location may result in an incremental increase or decrease in a player's score, expulsion from a game, the addition of a handicap to a player, a time penalty, or any variety of other consequences that may be associated with gaming and related activities.

During operation of gaming unit 1 display 4 will provide a visual indicator to an operator of that individual's particular location upon a geographic or topographical map, which may include overlain fictitious features. Where unit 1 includes a wireless communication link and multiple gaming units are being used in the same region and/or for playing the same game, the particular geographic locations of the other associated units may be shown on the display (see FIG. 8). Preferably the location of the individual operating a particular unit will be indicated on display 4 by a character or icon different than those that identify other gaming unit whose locations are also shown on the display. The additional gaming units may be shown through the use of a generic indicator or, alternatively, may be shown through the use of a particular name, number or icon to differentiate between them.

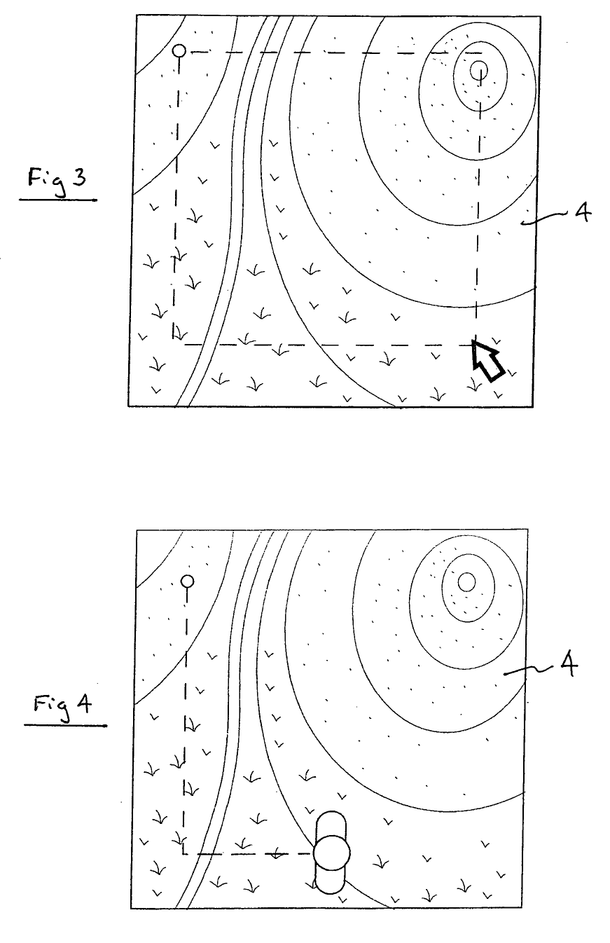

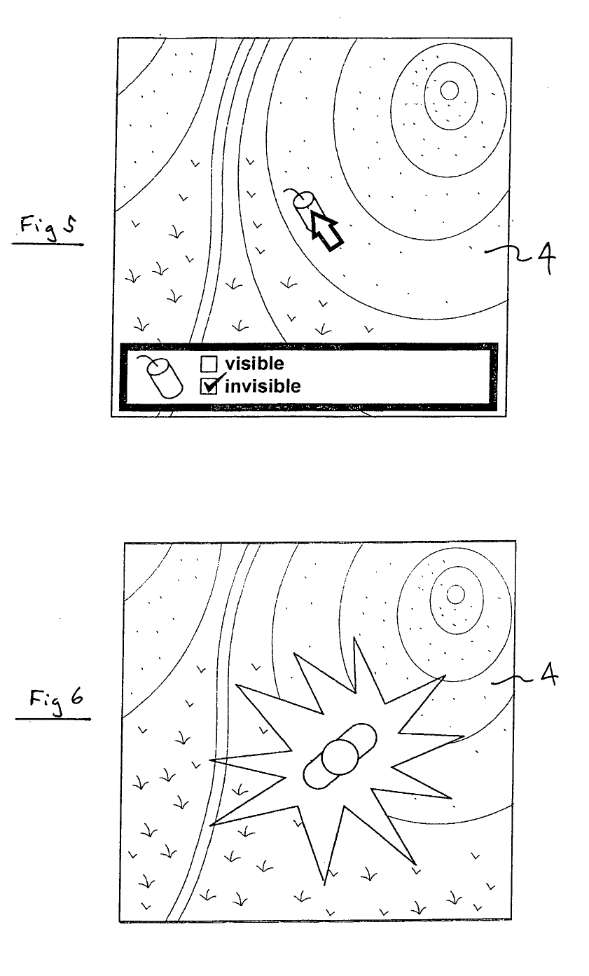

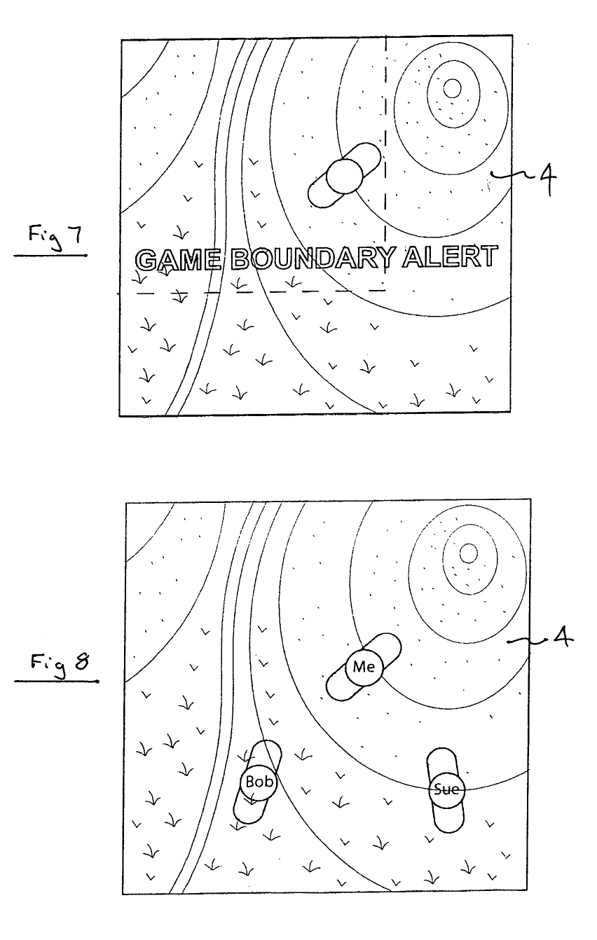

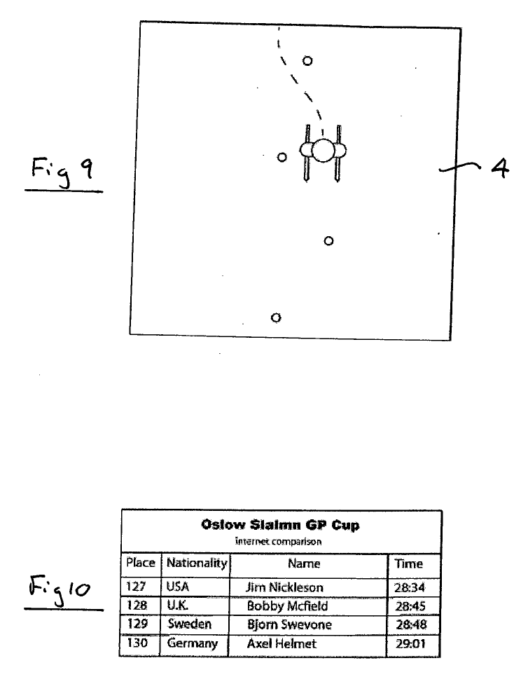

The software programmed into gaming unit 1 may also permit a player to define a geographic “play zone” that may be utilized by that individual player or used by multiple players engaged in the same activity. A play zone can be defined through moving a cursor across display 4 using keypad or user interface 9, and thereafter dragging a boundary box (see FIG. 3) or physically walking around a game boundary (see FIG. 4) to define a game zone. Once defined, the game or play zone is stored in memory module 5 and becomes one of the parameters for the game or event. For multiple individuals using a plurality of gaming units engaged in the same activity, the limits of the game or play zone may be communicated to other units and/or a central server or base station. Once a game or play zone has been defined, unit 1 or a base station can alert an individual in the event that they approach or cross the pre-defined boundary (see FIG. 7).

With particular reference to FIGS. 5 and 6, operation of gaming unit 1 also permits a player or central server or base station to create and position a synthetic or fictitious object to enhance game play or the enjoyment of a particular activity. The synthetic or fictitious objects will typically have characteristics that are defined by the type of game that is being played and could be physically shown on display 4 or could be “invisible” to a player and not made known until processor 3 determines that the player physically occupies the same geographic position as the synthetic or fictitious object. For example, a player may use keypad or user interface 9 to place a fictitious mine at a particular real world co-ordinate as depicted upon display 4 and choose to make the mine visible or invisible. When a player is determined to occupy the same real world co-ordinates as the mine certain consequences may result having an effect on the play of the game. Where the object is a fictitious mine the player may be determined to have become injured, may be terminated from playing any further, may have a deduction in points, or may be subjected to some other form of penalty. In other instances the fictitious object may represent a protective or safe area, a first aid station, provisions or supplies, treasure, bonus points, or any one of a very wide variety of other features or characteristics common to gaming. In a further variation, a plurality of individuals may be engaged in the same game or activity and divided into teams where particular synthetic or fictitious objects are visible to the team that places them and invisible to opposing teams. In these regards FIG. 5 illustrates a fictitious object that is placed at specific real world geographic co-ordinates by an individual and that is identified as being invisible to other players. FIG. 6 is an illustration showing the display on an opposing player's gaming unit where that player has moved and occupies the same real world geographic coordinates as the location of the fictitious object.

A further feature of a preferred embodiment of portable gaming unit 1 is the ability of the unit to record the movements and interactions of a player (or players) throughout the playing of a game or during a particular activity. Processor 3 is programmed so as to record the physical movements of GPS receiver 2 over the face of the earth (and hence the physical movements of the individual holding unit 1) and to store historical data associated with those movements in memory module 5. Unit 1 may also permit the storage of the movement of other gaming units through communications transmitted and/or received by wireless communication links 17. In addition to the movement of one or more gaming units, processor 3 may record attributes of the game as it is played. For example, times and scores, the placement of synthetic or fictitious objects, the velocity of an individual's movement, and where inertia measurement sensors are included within the gaming unit an individual's attitude and rate of acceleration and deceleration, may be stored in memory. Preferably the historical data is recorded in the removable portion of memory module 5 such that the data can be easily and readily extracted from portable gaming unit 1 and installed into a secondary or third party processor, computer or gaming device such as an X box™ or Playstation™. Depending upon the particular structure of the removable portion of memory module 5, the transportable memory may be directly insertable into the computer or game device, or may require an adapter module that allows the third party system to retrieve and use the stored data.

Once the historical stored data has been downloaded into a third party computer or gaming device, that device, in association with pre-installed game replay software, will read the recorded data and re-create the game or activity that was engaged in by the individual or the group of individuals as the case may be. With appropriate game replay software the third party computer or game device will permit the replay of the recorded events through the use of animation in a virtual reality domain having a visual appearance similar to that of a television program or movie. The computer or gaming device utilized for replay purposes will also preferably include interactive features such as a freeze command, perspective view, bird's eye view, follow the leader, and other commands commonly used in the art of digital gaming.

Through the connection of the third party computer or gaming device to the Internet, there will be presented the ability to replay and re-experience games and events simultaneously with others at various locations around the world without the limitations associated with the use of radio, cellular or pager based transmissions. In addition, it will be appreciated that the invention will permit individuals to engage in particular games or activities by themselves, and store the historical data associated with such games and activities in memory module 5, download that historical data into a third party computer or gaming device, and then effectively replay the game or event with others who have engaged in similar activities at other locations around the world in an animated virtual reality domain and in a manner that presents the appearance that the individuals are competing against one another in the same game. For example, an individual could physically race through a particular slalom course and later replay that race on a third party computer connected to the Internet with others that have traversed the same slalom course to effectively present the appearance of a multiple player race in a virtual reality domain.

Further aspects and features of the invention will be exemplified through reference to the following examples.

### EXAMPLE 1

Four people decided to play a game of electronic tag. Each individual player is provided with a portable gaming unit 1 having “tag” software pre-loaded upon it. The game of tag has a simple set of rules that most people understand, one player is “it” and runs to “tag” another. Pursuant to the invention, portable gaming unit 1 allows for an enhanced version of tag to be played where the players can position safe zones to evade the one who is “it”. A safe zone is a synthetic or fictitious object that is identified upon the screen of individual gaming units and that has an attribute that should a player who placed the safe zone upon the screen enter that particular area he or she cannot be tagged.

To begin the game one of the players maps out a game zone by walking a boundary and allowing his or her portable gaming unit to track the route. Once the game zone has been completed wireless communications link 17, or the exchange of memory module 5, allows sharing of the geographic limitations of that zone with the other players. Each individual player then is provided a time limit within which to position their safe zones, which may be placed at any place within the game zone by either moving a cursor on a display or by physically walking across the face of the earth to a particular geographic location and entering that location as a safe zone. Once each player has positioned their respective safe zones the geographic locations of the zones are shared with the other individuals, again through the operation of wireless communications links 17 or the exchange of memory module 5. The individual safe zones may be located by means of any desired icon on the individual displays of each portable gaming unit.

The game is started by one of the players who activates the appropriate keys on the keypad or user interface 9 causing all of the gaming units to communicate and randomly select one of the players to be tagged first. All of the individual units are then updated with respect to who is “it”, after which that individual's icon on the displays of each portable gaming unit is highlighted or otherwise noted in a distinct colour or fashion. The player that is “it” thereafter runs toward other players and is able to tag an opposing player by getting within a pre-determined geographic radius of another player. The amount of time taken for a player that is “it” to tag an opposing player is recorded and used to calculate a score. The game continues with the new player that has been tagged now designated as being “it”. As the game progresses player positions are continuously updated through GPS co-ordinates and by means of the wireless communication links in the individual gaming units.

As the game is played historical data concerning individual player movements and game parameters is continuously stored for possible downloading into a third party computer or gaming device, to be later replayed in an animated format in a virtual reality domain.

### EXAMPLE 2

A group of people wish to compare their skills at slalom skiing, car racing, waterskiing or some similar event but are unable to coordinate a common time or place to demonstrate such skills, or perhaps they are widely dispersed geographically. They therefore decide to demonstrate their skills by separately competing and comparing their skills in the “virtual word”. Each individual player is, as in Example 1 above, provided with a portable gaming unit 1 having appropriate software pre-loaded upon it. The software and GPS unit allow the player to establish, at a place and/or time of their choosing, a slalom course with markers positioned at the same relative locations as one or more other players. Pursuant to the invention, portable gaming unit 1 allows the player to record his or her passage through the slalom course along with their relative motion, speed, acceleration, attitude and other information. Such information is recorded moment by moment in memory module 5 for later replay in an animated format during playback on a desk top computer or consumer gaming unit, along with an animated 3-dimensional representation of the environment.

To begin the game one player maps out a game zone and course with gaming unit 1 by placing markers at particular locations, along with boundary markers as appropriate for the game or skill being demonstrated or played. Once the game zone has been completed the course and markers can be shared with other players by use of the removable memory portion, by subsequently connecting the game device to an Internet link, or through the use of wireless communications link 17. By this or similar means the player may share geographic information with the other players. Each individual player is then provided with a time limit within which to create a similar course or within which to visit the same course and demonstrate their skills. The recording of an individual's performance is started through activating the appropriate keys on the keypad or user interface 9 of gaming unit 1, causing the gaming unit to record the motion of the individual during their transit of the course or performance of various skills. The movement of the individual through the course may also be displayed on screen 14 or heads-up display 15 (See FIG. 9).

Once each player has recorded their “performance” on the same or a similar course at a remote location the recorded performances may be shared with the other individuals, once again through the operation of wireless communications link 17 or by the connection of the unit to a suitable Internet or other communications link. The recorded data concerning the movements and game parameters of individual players may also be downloaded through the Internet into a third party software program that tracks the performance of each player and maintains a performance ranking (See FIG. 10). As in Example 1 described above, it would be also possible to download the recorded data from multiple players into a third party computer or gaming device to be later replayed in an animated format in a virtual reality domain.

It is to be understood that what has been described are the preferred embodiments of the invention and that it may be possible to make variations to these embodiments while staying within the broad scope of the invention. Some of these variations have been discussed while others will be readily apparent to those skilled in the art. For example, while it is expected that in most instances the geographic location of the portable gaming unit in accordance with the described invention will be determined based upon GPS signals, in an alternate embodiment cellular or pager triangulation could be utilized or, where available, Loran C signals could be used to determine geographic positions. In addition, while it is expected that wireless communications between respective gaming units will be accomplished using radio signals in the Family Radio Signal (FRS) frequency range, other higher frequencies, or pager or cellular communications could equally be used.

I claim:

1. An apparatus to permit real time movements and events experienced by one or more individuals to be recorded for subsequent replay in a virtual reality domain, the apparatus comprising:
(i) a GPS receiver for receiving a plurality of GPS signals from a plurality of satellites;
(ii) a processor operatively connected to said GPS receiver and programmed to calculate the position of said GPS receiver relative to the surface of the earth based upon said received GPS signals;
(iii) a memory module operatively connected to said processor, said processor storing in said memory module data corresponding to the calculated position of said GPS receiver and the movement of said GPS receiver for a time interval, said memory module further storing data corresponding to specific events experienced by an operator of said apparatus during said time interval; and,
(iv) means to permit said data corresponding to the movement of said GPS receiver and said data corresponding to events experienced by said operator to be downloaded into the memory of a secondary processor for replaying and simulating said movement of said GPS receiver and the experiencing of said events in a virtual reality domain.

2. The apparatus as claimed in claim 1 received and contained within a portable, handheld housing and powered by an independent internal power supply.

3. The apparatus as claimed in claim 1 including a display panel operatively connected to said processor to visually display the position of said GPS receiver on an overlay map or grid.

4. The apparatus as claimed in claim 3 wherein said display panel comprises an LCD screen.

5. The apparatus as claimed in claim 3 wherein said display panel comprises a heads-up display formed through the projection of an image onto the surface of a visor worn by an operator of said apparatus.

6. The apparatus as claimed in claim 1 wherein said memory module includes a removable portion, said data corresponding to the calculated position of said GPS receiver, the movement of GPS receiver and said specific events experienced by an operator of said apparatus stored in said removable portion of said memory, said removable portion of said memory capable of being disconnected from said apparatus for independent connection to said secondary processor.

7. The apparatus as claimed in claim 1 including one or more inertia measurement sensors connected to said processor.

8. The apparatus as claimed in claim 7 wherein said inertia measurement sensors include 1 or more accelerometers.

9. The apparatus as claimed in claim 7 wherein said inertia measurement sensors include one or more gyroscopes.

10. The apparatus as claimed in claim 7 wherein upon receipt of signals from said 1 or more inertia measurement sensors and receipt of signals from said GPS receiver said processor calculates and records in said memory module one or more of the location of said GPS receiver, the attitude of said apparatus, the acceleration of said apparatus, the deceleration of said apparatus, the velocity, of said apparatus and the time associated with the movement of said apparatus.

11. The apparatus as claimed in claim 3 wherein said overlay map or grid is indicative of the geography and man-made structures associated with the portion of the earth's surface within which said GPS receiver is located.

12. The apparatus as claimed in claim 3 wherein said overlay map or grid is indicative of a fictitious location or includes fictitious objects.

13. The apparatus as claimed in claim 3 including a radio receiver operatively connected to said processor, said radio receiver receiving radio signals from an independent radio transmitter, said radio signals causing said processor to display information on said display panel or causing a said processor to alter images displayed on said display panel.

14. The apparatus as claimed in claim 3 including a radio transmitter and a radio receiver operatively connected to said processor, said radio receiver receiving radio signals transmitted by one or more other such apparatuses wherein said radio signals are indicative of the location of said one or more other apparatuses, said processor programmed to received said radio signals and identify the position of said one or more other such apparatuses on said display panel.

15. A method of electronic gaming utilizing an electronic gaming unit wherein real time movements of one or more individuals or players are recorded for later replay in a virtual reality domain, the method comprising the steps of:
(i) with a GPS receiver, receiving a plurality of GPS signals generated from a plurality of orbiting satellites and directing said received signals to a processor programmed to calculate the position of said GPS receiver relative to the surface of the earth based upon said received GPS signals;
(ii) in a memory module operatively connected to said processor, storing data corresponding to the calculated position of said GPS receiver and data corresponding to the movement of said GPS receiver for a time interval; and,
(iii) transporting said data corresponding to the position and the movement of said GPS receiver to a secondary processor for replaying and simulating said movement of said individual and said GPS receiver in a virtual reality domain.

16. The method as claimed in claim 15 including the further step of storing in said memory module further data corresponding to specific events experienced by said individual while operating said GPS receiver and transporting said data corresponding to said specific events to said secondary processor for replay with said data corresponding to the position and the movement of said GPS receiver.

17. The method as claimed in claim 15 including the step of transmitting a signal from said processor to a display panel causing said display panel to visually display the position of said GPS receiver on an overlay map or grid.

18. The method as claimed in claim 17 wherein said GPS receiver, said processor, said display panel and said memory module are contained within a portable handheld housing, said movement of said GPS receiver comprising an individual traversing an area or a pre-determined course over the face of the earth while carrying said portable handheld housing.

19. The method as claimed in claim 15 wherein said processor is operatively connected to a heads up display, said method including the step of causing said processor to activate said heads up display to project an image of an overlay map or grid for viewing by an individual and to display the relative movement of said GPS receiver on said projected overlay map or grid.

20. The method as claimed in claim 15 wherein said data corresponding to the calculated position of said GPS receiver and said data corresponding to the movement of said GPS receiver is stored in a removable portion of said memory module, said step of transporting said data corresponding to the calculated position of said GPS receiver and said data corresponding to the movement of said GPS receiver to a secondary processor comprising the disassociation of said removable portion from said memory module and the transportation of said removable portion for physical connection to said secondary processor.

21. The method as claimed in claim 17 wherein said overlay map or grid is indicative of a fictitious location, said method including the further step of moving said GSP receiver over the face of the earth corresponding to a pre-determined path on said overlay map or grid of said fictitious location.

22. The method as claimed in claim 15 including using one or more inertia measurement sensors to determine one or more of the attitude, the acceleration and the deceleration of said electronic gaming unit.
